(19) United States
(12) Patent Application Publication
(10) Pub. No.: US 2023/0284819 A1
(43) Pub. Date: Sep. 14, 2023

(54) STEAM WAND AND METHOD FOR FROTHING MILK

(71) Applicant: LA MARZOCCO S.R.L., Scarperia (FI) (IT)

(72) Inventors: Andrea DIONISIO, Scarperia (FI) (IT); Simone PIERI, Scarperia (FI) (IT)

(21) Appl. No.: 17/769,256

(22) PCT Filed: Oct. 15, 2020
(86) PCT No.: PCT/IB2020/059673

§ 371 Date: Apr. 14, 2022

(30) Foreign Application Priority Data
Oct. 16, 2019 (IT) 102019000018983

(51) Int. Cl. A47J 31/44

(52) U.S. Cl. CPC A47J 31/4489

(57) ABSTRACT

A diffuser (20) for a steam wand (10) for frothing a quantity of milk for the preparation of a beverage, wherein said diffuser (20) is configured to be connected to a steam wand (10) which receives steam from a steam tank and/or from a steam generator, wherein said diffuser (20) comprises a longitudinal axis (22) and a plurality of steam outlet holes (21), each having an outlet hole axis (23), wherein at least one outlet hole (21) has its axis (23) which is skew with respect to said longitudinal axis (22) of the diffuser (20).

### TECHNICAL FIELD

The present invention relates, in general, to the sector of machines for the preparation of beverages based on coffee or the like. More particularly, the present invention relates to the preparation of beverages (such as a cappuccino) based on coffee or the like with the addition of frothy milk (typically also heated). More specifically, the present invention relates to a steam wand and a nozzle for a steam wand, as well as a method of frothing milk.

### STATE OF THE ART

As is known, an espresso coffee machine prepares coffee by forcing pressurized water to the boiling point by means of a puck of ground coffee and a filter to produce a dense and concentrated coffee drink called espresso or espresso coffee. Many espresso coffee machines are equipped with steam producing means for heating and/or foaming a certain amount of water, milk or the like. Such steam producing means typically comprise a steam tank such as a steam boiler, a steam circuit, a steam regulating valve and a steam wand ending with a steam emitting nozzle.

Typically, an espresso coffee machine operator (also referred to as “bartender”) introduces the steam wand into a jug or similar container containing a quantity of liquid to be heated or foamed. He/she then opens the steam circuit so that the steam exits from the nozzle at the end of the wand. During the steam escape, the bartender moves and/or translates and/or rotates the jug in order to obtain milk (or the like) at the correct temperature and with the correct foaming and consistency.

The resulting hot frothy milk is typically used to prepare a cappuccino, a “coffee macchiato” (a single or double espresso coffee with a relatively small amount of hot frothy milk, served in a coffee cup) or any one of a known plurality of espresso coffee variants. Hot frothed milk is also used to prepare other beverages, not necessarily coffee-based, such as hot chocolate.

### SUMMARY OF THE INVENTION

For the present description and the present claims, the term “milk” will include any liquid food comprising milk of animal origin, vegetable milk (i.e. milk extracted from plants) and milk obtained from chemical processes. The milk of animal origin comprises, for example, cow's milk, goat's milk and sheep's milk. Vegetable milk comprises the so-called soy milk, almond milk, coconut milk and rice milk.

For the present description and the present claims, the term “espresso coffee machine”, “coffee machine” or “machine” will be referred to a machine for the production of hot drinks such as espresso coffee, cappuccino or the like. While, typically, such machines use ground coffee to produce beverages, they may also use powder from other cereals, such as barley.

The means for producing steam can be integrated, at least in part, in an espresso coffee machine or can be integrated, at least in part, in a machine which is separated from an espresso coffee machine, for example they can be integrated in a stand-alone machine.

Unless otherwise indicated, the term “milk frothing” or “milk foaming” will also include heating the milk and providing the milk with a certain adequate consistency using steam and/or hot air so that the milk increases in volume and generates a microbubble structure. In other words, to assemble the milk means to provide a dispersion (foam) of steam and air in the milk, and at the same time to increase the temperature of the mixture. The correct milk foaming operation is fundamental in order to be able to obtain beverages which reach certain taste and consistency. The temperature and the percentage of gas dispersed in the liquid are indispensable values for correct frothing. As mentioned above, a steam wand terminates with a diffuser which has the task of regulating the flow rate and directing the steam out of the delivery system, so that the steam can be used in the desired manner.

The Applicant has noted that conventional diffusers have some critical issues when they are used. The operator must in fact be able to trigger a suitable vortex in the milk; to do this it is necessary to move the jug and to move it according to particular angles, as well as to position the diffuser in a precise area inside the jug.

In doing so, there is a risk of generating unwanted air bubbles inside the foam, and the ability to control the amount and finish of the foam (texture) is reduced. Moreover, it is difficult to maintain control of the temperature since inhomogeneities are formed inside the jug and the temperature of the milk is empirically evaluated by the bartender with his hand resting on the outer wall of the jug.

The Applicant believes that a misalignment of the holes (i.e. holes on different planes) is not advisable in a steam diffuser as it contravenes the principle underlying a behavior considered to be optimal. The optimal behavior, according to the Applicant, envisages making the jets cooperate so as to create a single turbulence vortex.

In this sense, placing the holes at different heights reduces their interaction in generating a single vortex.

In addition, the Applicant has verified that traditional systems with coincident jets directed downwards create as many independent vortices as there are jets.

The Applicant has also understood that the horizontal component of the steam output must be much greater than the vertical one so that the speed of the steam has a strong tangential head, and therefore leads to the generation of a single axial vortex to the diffuser. Consequently, the constructive angle of the holes should be as small as possible.

However, it is necessary that the jet is not directed too horizontally but has a vertical component to prevent the user from being accidentally hit by the jet of steam.

The Applicant has identified the optimal angle as a compromise between the two needs equal to about 30°. With this angle, the triggered vortex is sufficiently powerful, and the risk of hitting the barista with the jet of steam is reduced. However, the range of angles that can be used is between 20° and 45°; according to other embodiments 25°-45°; according to other embodiments 25°-40°.

According to the Applicant, the aforementioned problem can be solved by exploiting the kinetic energy of the steam to trigger a vortex in the milk, without having to resort to any inclination or decentralization of the jug. By doing so, the assembly operation becomes simpler and more repeatable. To this is added a better control over the temperature of the mixture, given the greater heat input in the forced convection regime.

According to a first aspect of the present invention, there is provided a diffuser for a steam lance for mounting a quantity of milk for preparing a beverage, wherein said diffuser is configured to be coupled to a steam wand receiving steam from a steam tank and/or a steam generator, wherein said diffuser comprises a longitudinal axis and a plurality of steam outlet holes, each having an output hole axis, wherein at least one outlet hole has its axis that is skewed relative to said longitudinal axis of the diffuser.

According to embodiments, all the axes of the plurality of holes are skewed with respect to said longitudinal axis of the diffuser.

Typically, the diffuser comprises a blind longitudinal hole with a bottom section having a larger diameter and wherein the steam outlet holes communicate with the longitudinal hole at the bottom section having a larger diameter. In this way, the holes can be arranged on a circumference with a larger diameter. Therefore, the arm with respect to the center is greater than in known solutions.

The reason the blind longitudinal hole has been enlarged is to allow for more spaced outlet holes. It is therefore an advantageous condition for increasing the center distance of the holes. The effect is to increase the swirling of the flow.

According to embodiments, the diffuser further comprises a base and wherein the steam outlet holes open at the base.

According to embodiments, the diffuser further comprises a base, a side wall and a curved surface connecting the base and the side wall, and wherein the steam outlet holes open onto the curved surface.

According to embodiments, the outlet holes have the same cross-sectional shape.

According to embodiments, the section of the outlet holes is enlarged in proximity to the outer surface of the diffuser.

According to embodiments, the external section of the outlet holes is arranged on a plane perpendicular to the longitudinal axis of the diffuser. In other words, the exit of all the holes is on a single plane, at a single height.

According to embodiments, a ratio B/R is greater than or equal to 0.5 and an inclination angle A is between 0° and 45°, wherein
R represents the outer radius of the diffuser at the center of a steam outlet hole,
B represents the arm calculated as the distance between the axis of the diffuser and the projection of the axis of the outlet hole on a plane perpendicular to the axis of the diffuser,
B/R represents the relationship between the arm B and the radius R, and
A represents the angle of inclination of the axis of an outlet hole with respect to a plane orthogonal to the longitudinal axis of the diffuser.

Advantageously, the B/R ratio is between 0.5 and 0.80, or between 0.55 and 0.75, or between 0.60 and 0.70, for example 0.67.

According to embodiments, the angle A is between 20° and 45°, according to other embodiments, the angle A is between 25° and 45°, according to other embodiments the angle A it is between 25° and 40°, for example 30°.

According to embodiments, the steam outlet holes are even in number such as two, four, six or eight. In other embodiments they are odd such as three, five, seven, . . . .

According to another aspect, the present invention provides a steam wand for frothing a quantity of milk for preparing a beverage, comprising a tube connectable to a steam tank and/or a steam generator and also comprising a diffuser of the above type.

According to a third aspect, the present invention provides a machine for frothing a quantity of milk for preparing a drink, comprising a steam tank and/or a steam generator and a steam wand with a tube connected to said tank and/or to said steam generator, wherein said steam wand also comprises a diffuser of the above type.

According to a fourth aspect, the present invention provides an espresso coffee machine or a stand-alone single-shot machine comprising a steam wand of the above type.

According to another aspect, the present invention provides a method for frothing a quantity of milk for preparing a beverage, comprising:
providing a steam wand which receives steam from a steam tank and/or a steam generator, wherein said steam wand comprises a steam diffuser, wherein said diffuser comprises a longitudinal axis and a plurality of steam outlet holes,
wherein the diffuser comprises a longitudinal hole with a bottom section with a larger diameter and wherein the steam outlet holes communicate with the longitudinal hole in correspondence with the bottom section with a larger diameter,
causing the steam to exit at least one outlet hole in a direction identified by an axis which is oblique with respect to said longitudinal axis of the diffuser.

### BRIEF DESCRIPTION OF THE DRAWINGS

The present invention will become completely clear from the following detailed description, given by way of non-limiting example, to be read with reference to the attached drawings, in which:

FIG. 1 shows an espresso coffee machine with a steam wand;

FIG. 2 shows a stand-alone milk assembly machine with a tube which receive steam from a steam tank or steam generator;

FIG. 3 shows a steam wand with a diffuser according to the invention;

FIG. 4 and FIG. 4A are a side view and a cross section of a steam wand diffuser according to a first embodiment of the invention, respectively;

FIG. 5 and FIG. 5A are a side view and a cross-section of a steam wand diffuser according to a second embodiment of the invention, respectively;

FIG. 6 is an axonometric view of a steam wand diffuser according to a third embodiment of the invention;

FIG. 7 is a bottom plan view of the diffuser of FIG. 6;

FIG. 8 is a side view of the diffuser of FIG. 6;

FIGS. 8A and 8B are longitudinal sections of the diffuser of FIG. 8, made along the planes A-A and B-B of FIG. 8; and

FIG. 9 and FIG. 9A are a side and top plan view of a jug used for temperature tests, respectively.

### DETAILED DESCRIPTION

The present invention exploits the kinetic energy of the steam to trigger a vortex in the milk, without having to resort to any inclination or decentralization of the jug. In doing so, the frothing operation becomes much simpler and repeatable. To this is added a better control over the temperature of the mixture, given the greater heat input under forced convection.

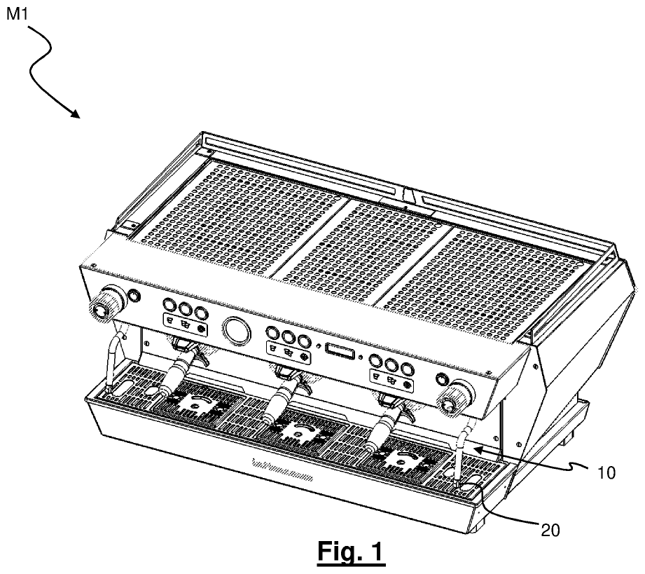

FIG. 1 shows an espresso coffee machine M1 comprising a steam wand 10 according to an embodiment of the present invention. Of course, the machine M1 of FIG. 1 is purely exemplary and the steam wand 10 of the invention can be mounted to any espresso coffee machine.

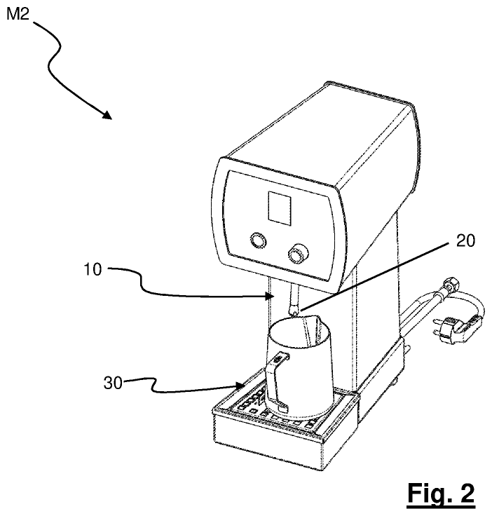

FIG. 2 shows a stand-alone machine M2 for emitting steam. The machine M2 may contain a steam tank or steam generating means. Alternatively, the machine M2 could comprise a pipe for connecting it to a steam tank or to an external steam generator. Steam is used to froth a quantity of milk in a jug 30. The machine M2 comprising a steam wand 10 according to an embodiment of the present invention. Of course, the machine M2 of FIG. 2 is purely exemplary and the steam wand 10 of the invention can be mounted to any other machine.

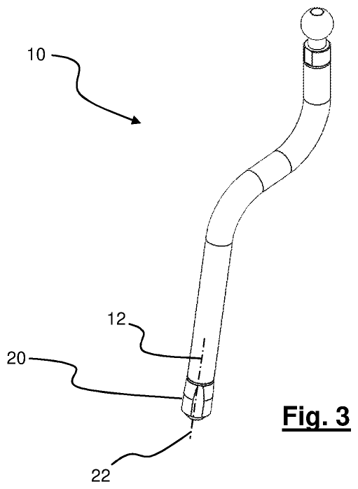

FIG. 3 shows a steam wand 10 with a diffuser 20 according to the invention. The steam wand 10 comprises a tube 11 bent to form two curves. The tube 11 comprises a ball joint at its upper end and a diffuser 20 at its lower end. The steam typically travels along the steam wand 10 from the upper end toward the opposite end and exits from the diffuser 20.

The steam wand comprises a longitudinal axis 12 at its end portion, near the diffuser 20.

The longitudinal axis 12 of the steam wand 10 near the diffuser coincides with the longitudinal axis 22 of the diffuser 20.

The diffuser 20 comprises a steam outlet hole 21, but preferably a plurality of steam outlet holes 21. Each outlet hole 21 comprises an axis 23, referred to as the axis of the outlet hole.

According to the present invention, at least one steam outlet hole 21 has its own axis 23 which is skewed with respect to the longitudinal axis 22 of the diffuser 20. In the case of a plurality of holes 21, preferably all the holes 21 have their own axis 23 which is skewed with respect to the longitudinal axis 22 of the diffuser 20.

For the purposes of the present description, it is intended that the axis 22 of the diffuser 20 and the axis 23 of an outlet hole 21 are skew when they do not lie on a common plane, i.e. they are not coplanar. In other words, the axis 22 of the diffuser 20 and the axis 23 of an outlet hole 21 are neither incident nor parallel separate nor parallel coincident.

By imagining the hole 21 as a vector with a direction corresponding to its axis 23 and pointing toward the steam outlet, the projection of these vectors on a plane orthogonal to the axis 22 of the diffuser generates non-zero angular moment with respect to the axis of the diffuser.

This system ensures the triggering of turbulence which generates a vortex in the vapor, due to the resulting non-zero moment of the forces. The vortex also allows the temperature to be uniform, avoiding too hot zones at the steam outlet (caused by recirculation and stagnation) and too cold zones at the edges of the milk container to be foamed (jug).

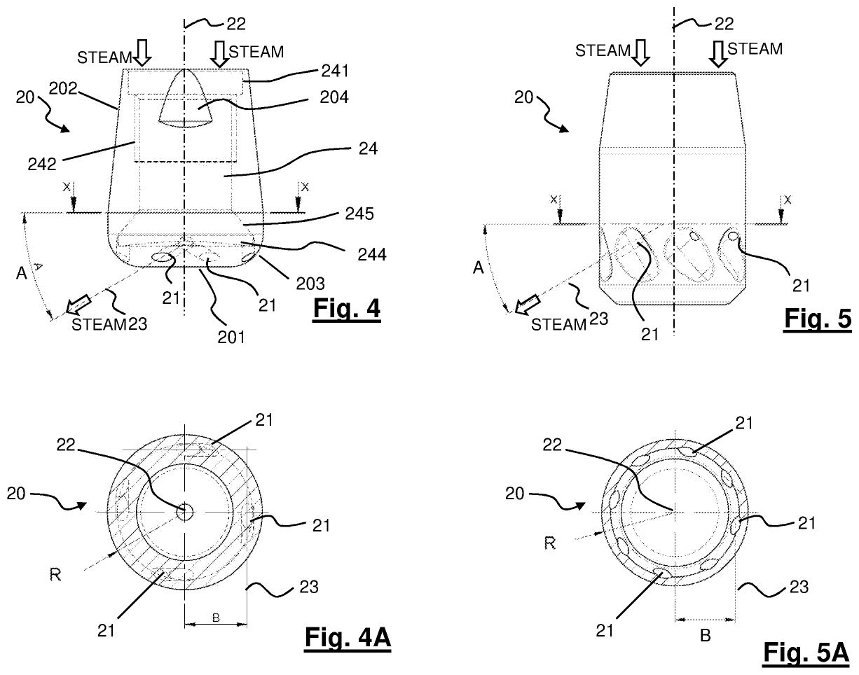

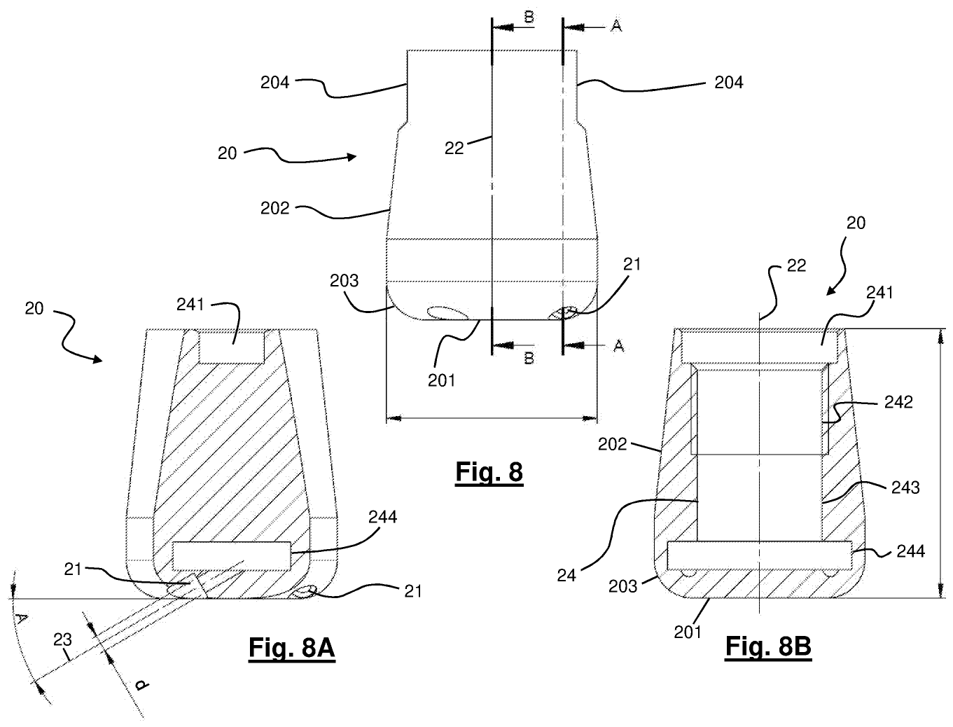

With reference to FIGS. 4-8, 8A and 8B, the following definitions are given:
R: the outer radius of the diffuser at the center of a steam outlet hole 21,
B: the arm calculated as the distance between the axis 22 of the diffuser and the projection of the axis 23 of the outlet hole 21 on a plane perpendicular to the axis of the diffuser (FIG. 4A),
B/R: ratio between the arm B and the radius R, and
A: angle of inclination of the axis 23 of the outlet hole 21 with respect to a plane orthogonal to the longitudinal axis 22 of the diffuser.

According to the present invention, the diffuser 20 may comprise a single hole 21 or a plurality of holes 21. Preferably, the holes 21 of said plurality of holes are even in number, for example two, four, six, eight or more. Alternatively, the holes 21 are in an odd number, such as three, five, seven, nine or more.

Preferably, the centers of the steam passage holes are arranged on a same plane perpendicular to the axis 22 of the diffuser 20.

The steam outlet holes 21 have any diameter. Typically, they have a diameter of from about 0.9 mm to about 1.6 mm. Preferably, the holes 21 have a diameter of between about 1.0 mm and about 1.6 mm. In embodiments, the holes 21 have a diameter of between about 0.9 mm and about 1.3 mm. In embodiments, the holes 21 have a diameter of between about 1.0 mm and about 1.2 mm, for instance 1.2 mm.

Preferably, the outlet holes 21 have a circular cross-section. Alternatively, the outlet holes 21 have a cross-section different from the circular one, for example elliptical or oval.

Preferably, the holes 21 all have a same section, for example they are all circular or all oval.

The holes 21 have a constant cross-section, for example the holes 21 are circular or oval throughout their length.

According to the present invention, the inclination angle A is between 20° and 45°, measured as shown in FIGS. 4 and 5. According to embodiments, the inclination angle A is between 25° and 45°. According to further embodiments, the inclination angle A is between about 25° and about 40°. According to further embodiments, the inclination angle A is between about 25° and about 35°, for instance about 30°.

According to the present invention, the ratio B/R is greater than or equal to 0.5. According to embodiments, the ratio B/R is between 0.50 and 0.80. According to embodiments, the ratio B/R is between 0.55 and 0.75. According to embodiments, the ratio B/R is between about 0.60 and 0.70, for example it could be 0.67.

According to embodiments, the diffuser 20 has a shape similar to that of the bottom of a flask, with the bottom having a larger diameter than the top. The base 201 of the diffuser 20 is connected to the side wall 202 through a curved surface 203. The side wall 202 preferably comprises two flat surfaces 204 for screwing and/or unscrewing the diffuser 20 with respect to the steam wand 10.

Inside, the diffuser 20 comprises a longitudinal hole 24, having its axis coinciding with the longitudinal axis 22 of the diffuser 20. The hole 24 can comprise a seat 241 for a gasket or O-ring (not shown). The hole 24 may include a threaded section 242 for screwed coupling to the steam wand 10. The hole 24 may include a non-threaded section 243 with a first substantially constant diameter. The hole 24 may comprise a bottom portion 244 with a second diameter greater than the first diameter of the portion 243. The portions 243 and 244 can be joined by means of a portion with an increasing diameter as shown in FIG. 4.

The passage holes 21 are through holes that connect the longitudinal hole 24 with the outside of the diffuser. Preferably, the through holes 21 communicate with the bottom portion 244 with a larger diameter.

According to a variant, the passage holes 21 open at the side surface of the section 244. According to another variant, the passage holes 21 open at the bottom of the hole 24.

The fact that the longitudinal hole 24 widens at the bottom favors the escape of the steam and in particular increases the whirling of the flow. Moreover, it allows to have passage holes 24 which are more mutually spaced, that is with the axes on a greater circumference, with the same diameter of the diffuser.

The passage holes 21 open outwards at the base 201 or, preferably, the curved surface 203. In this second case, they form an opening having an oval or elongated shape which favors the distribution of steam. The trailing edge can be flared.

The arrangement, number and inclination of the passage holes 21 creates an optimal flow of steam which causes a rotating or screwing effect that leads to an optimal assembly of the milk in the jug. Arm B is relatively large compared to the diameter of the diffuser and this creates a greater moment than known diffusers.

According to the invention, the holes 21 for the passage of the steam have a reduced length and this improves the processing precision and the performance of the steam escaping towards the outside.

In embodiments, a counterbore (i.e. an increase in the section) is provided before the exit of each hole. This has mainly two advantages.

The first advantage is based on fluid dynamic motifs. In fact, a further section change introduces a concentrated pressure drop which increases the Reynolds number of the steam. As a consequence there is an early transition from laminar fluid to turbulent fluid. The macroscopic result is a better frothing of the milk due to the greater quantity of entrained air and the better mixing that the turbulent fluid introduces.

The second advantage is based on technological reasons: the counterbore present at the head of the throttling hole allows to simplify the realization of the hole itself.

### Example 1 (FIG. 4)

Number of through holes 21: 4

Diameter of through holes 21: 1.2 mm

Angle A: 30°

Arm/radius Ratio (B/R): 0.8

### Example 2 (FIG. 5)

Number of through holes 21: 8

Diameter of through holes 21: 1 mm

Angle A: 30°

Arm/radius Ratio (B/R): 0.82

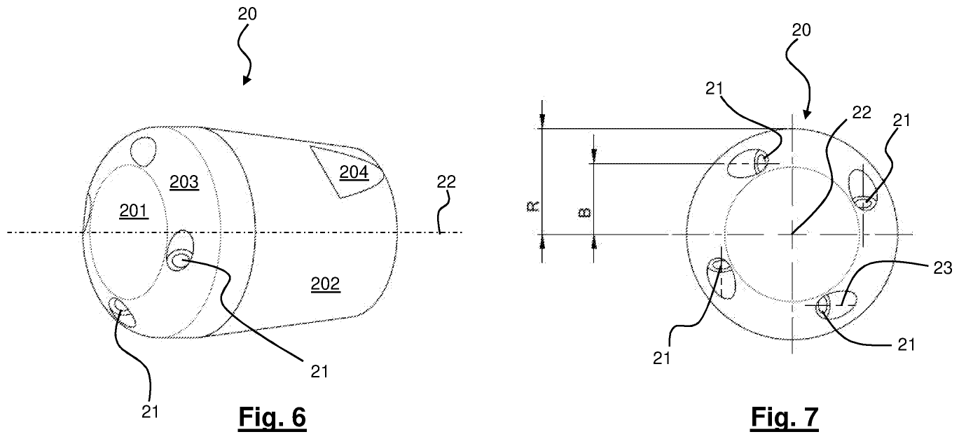

### Example 3 (FIGS. 6-8, 8A and 8B)

Number of through holes 21: 4

Diameter of through holes 21: 1.2 mm

Angle A: 30°

Arm/radius Ratio (B/R): 0.67

The Applicant has carried out some tests on a steam wand 10 equipped with a known diffuser and with a diffuser 20 of example 1 and example 2.

During the tests carried out with the diffusers according to the present invention, the milk jug has been kept substantially stationary, i.e. it has not been rotated as is usually done to mount the milk with a known steam wand, equipped with a diffuser of known type.

In order to verify whether the milk is properly mounted, the Applicant has evaluated the surface texture, the amount and persistence of the formed foam, and the temperature.

The tests carried out evaluated the surface texture according to the quantity of bubbles, with a visual comparison.

The amount and persistence of the foam was evaluated by pouring the content of the jug into a graduated cylinder. Three photographic shots have been obtained: The first as soon as the content is poured, the second after 90 seconds, the third after 300 seconds.

From these photos it has been possible to notice after how long there is separation between the liquid part and the emulsified part, and how much is the ratio between these two parts. The longer the separation time, the better the mounting quality. The greater the emulsified part than the liquid part and the better the quality of the frothing.

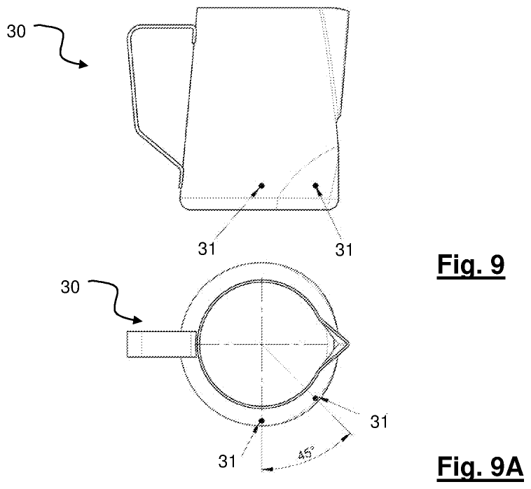

Finally, a temperature test was carried out. For the temperature test, two thermocouples 31 were positioned at 45° on the outer surface of jug 30 (as shown in FIGS. 9 and 9A), in order to evaluate possible differences in the temperature distribution. A smaller difference between the two thermocouples is an indication of better frothing quality.

A Strada AV espresso machine was used to perform the tests. The vapor pressure was fixed at 1.3 bar. A steel jug of 600 ml capacity was used. For each test, an amount equal to 300 g of whole milk was used. For the foam persistence test, a graduated glass cylinder, a scale and a video camera were used.

Performing the foam persistence test.
1) Filled the jug with 300 g of milk at a temperature of a refrigerator (about 4° C.).
2) Positioned the diffuser in the center of the jug.
3) Steam is supplied
4) Interrupted the steam supply after 20 s.
5) The frothed milk is photographed from above.
6) Poured the content into the graduated cylinder.
7) Photographed after 1 s, 90 s and 300 s.

Performing the foam persistence test.
1) Filled the jug with 300 g of milk at a temperature of a refrigerator (about 4° C.).
2) Positioned the diffuser in the center of the jug.
3) Steam is supplied
4) Interrupted the steam supply after 20 s.
8) Constantly monitored the temperature trend.

The results of the tests are summarized in Table 1 below:

TABLE 1

| | Known | Diffuser | Diffuser |
|---|---|---|---|
| | diffuser | of ex. 1 | of ex. 2 |
| Test | (comparative) | (invention) | (invention) |
| Superficial | SUFFICIENT | OPTIMAL | OPTIMAL |
| texture | | | |
| Quantity | GOOD | OPTIMAL | OPTIMAL |
| of foam | | | |
| Persistence | SUFFICIENT | GOOD | OPTIMAL |
| of foam | | | |
| Milk | HETERO- | HOMO- | HOMO- |
| temperature | GENEOUS | GENEOUS | GENEOUS |

It can be seen that there is better texture, better persistence of the foam, a greater quantity of foam and a lower temperature difference in the case of diffuser according to Examples 1 and 2 with respect to the known diffuser.

1. A diffuser for a steam wand for frothing a quantity of milk for the preparation of a beverage, wherein said diffuser is configured to be connected to a steam wand which receives steam from a steam tank and/or from a steam generator, wherein said diffuser comprises a longitudinal axis and a plurality of steam outlet holes, each having an outlet hole axis, wherein at least one outlet hole has its axis which is skew with respect to said longitudinal axis of the diffuser, wherein the diffuser comprises a longitudinal hole with a bottom section having a larger diameter and wherein the steam outlet holes communicate with the longitudinal hole at the bottom section having a larger diameter.

2. The diffuser of claim 1, further comprising a base and wherein the steam outlet holes opens on the base.

3. The diffuser of claim 1, further comprising a base, a side wall and a curved surface connecting the base and the side wall, and wherein the steam outlet holes opens at the curved surface.

4. The diffuser of claim 1, wherein all the axes of the plurality of holes are skew with respect to said longitudinal axis of the diffuser.

5. The diffuser of claim 1, wherein the outlet holes have the same cross section.

6. The diffuser according to claim 1, wherein the cross-section of the outlet holes is enlarged in proximity of the outer surface of the diffuser.

7. The diffuser according to claim 1, wherein the outer section of the outlet holes is arranged on a plane perpendicular to the longitudinal axis of the diffuser.

8. The diffuser according to claim 1, wherein:
R represents the outer radius of the diffuser at the center of a steam outlet hole,
B represents the arm, calculated as the distance between the axis of the diffuser and the projection of the axis of the outlet hole on a plane perpendicular to the axis, of the diffuser,
B/R represents the ratio between the arm B and the radius R, and
A represents the angle of inclination of the axis of an outlet hole with respect to a plane which is orthogonal to the longitudinal axis of the diffuser, and wherein the B/R ratio is greater than or equal to 0.5 and the angle A is between 0° and 75°.

9. The diffuser of claim 8, wherein the angle A is between 25° and 40°, preferably about 30°.

10. The diffuser according to claim 1, wherein the steam outlet holes are in even number such as two, four, six or eight in number.

11. A steam wand for frothing a quantity of milk for the preparation of a beverage, comprising a tube connectable to a steam tank and/or to a steam generator and further comprising a diffuser according to claim 1.

12. A machine for frothing a quantity of milk for the preparation of a beverage, comprising a steam tank and/or a steam generator and a steam wand with a tube fluidically connected to said tank and/or to said steam generator, wherein said steam wand further comprises a diffuser according to claim 1.

13. The machine of claim 11, wherein it is an espresso coffee machine or a stand-alone machine for frothing milk.

14. A method for frothing a quantity of milk for the preparation of a beverage, comprising:
providing a steam wand which receives steam from a steam tank and/or from a steam generator, wherein said steam wand comprises a steam diffuser, wherein said diffuser comprises a longitudinal axis and a plurality of steam outlet holes, wherein the diffuser comprises a longitudinal hole with a bottom section having a larger diameter and wherein the steam outlet holes communicate with the longitudinal hole at the bottom section having a larger diameter,
causing the steam to escape from at least one outlet hole along a direction identified by an axis which is skew with respect to said longitudinal axis of the diffuser.
